(19) United States
(12) Patent Application Publication
(10) Pub. No.: US 2024/0348019 A1
(43) Pub. Date: Oct. 17, 2024

(54) MULTIPLE-ENTRY I/O MODULE WITH MODULAR BUSBARS

(71) Applicant: DG Matrix, Inc., Raleigh, NC (US)

(72) Inventor: Ahsan Dar, Lahore (PK)

(73) Assignee: DG Matrix, Inc., Raleigh, NC (US)

(21) Appl. No.: 18/627,583

(22) Filed: Apr. 5, 2024

Related U.S. Application Data
(63) Continuation of application No. PCT/US23/29984, filed on Aug. 10, 2023.
(60) Provisional application No. 63/471,120, filed on Jun. 5, 2023.
(60) Provisional application No. 63/471,120, filed on Jun. 5, 2023.

(30) Foreign Application Priority Data
Apr. 17, 2023 (PK) 230/2023

(51) Int. Cl. H02B 1/20; B60L 53/30; H02J 7/00

(52) U.S. Cl. CPC H02B 1/20; B60L 53/30; H02J 7/0042

(57) ABSTRACT

A circuit breaker modular interconnect system includes a plurality of contactors attached to primary busbars. The primary busbars are configured to interlock with secondary busbars leading to terminals to which cables are able to attach. A connection module is fit around the interlock point between the primary busbars and the secondary busbars and then fixed in order to retain a strong connection between the primary and secondary busbars. The connection module is able to include a plurality of sections, lined with electrically conductive material and configured to surround the interlock points to assist in maintaining strong electrical connection between the primary and secondary busbars.

### CROSS-REFERENCES TO RELATED APPLICATIONS

This application relates to and claims priority from the following U.S. patent applications. This application claims priority to and the benefit of U.S. Provisional Patent Application No. 63/471,120, filed Jun. 5, 2023, which is incorporated herein by reference in its entirety. This application is a continuation of PCT Application No. PCT/US23/29984, filed Aug. 10, 2023, which claims priority to and the benefit of U.S. Provisional Patent Application No. 63/471,120, filed Jun. 5, 2023. PCT Application No. PCT/US23/29984 also claims priority to and the benefit of Pakistani Patent Application No. 230/2023, filed Apr. 14, 2023. This application also claims priority to and the benefit of Pakistani Patent Application No. 230/2023, filed Apr. 14, 2023. Each of the above referenced applications is incorporated herein by reference in its entirety.

### BACKGROUND OF THE INVENTION

### 1. Field of the Invention

The present invention relates to modular connection systems for breakers within an input/output (I/O) module, and more specifically to modular busbar connection systems providing for multiple interchangeable attachment points for attaching power supplying elements to a charger.

### 2. Description of the Prior Art

It is generally known in the prior art to provide input/output panels for chargers, such as electric vehicle chargers, providing for attachment of one or more cables for connecting different devices (e.g., electric vehicles) to a central power supply for a location. Input/output modules commonly include one or more contactors, with a single entry point for power to enter the module, as typically only a single power source (typically an electric grid connection or a generator) supplies power to the charging module. A plurality of individual breakers are attached to the busbars, connecting them to the main power output of the charger, and therefore to any connected power consuming device. The plurality of individual breakers are attached to a plurality of cables for providing power out of the charging system to one or more consuming devices, such as an electric vehicle.

Prior art patent documents include the following:

Korean Patent No. 101024727 for Diverging connector kit for industrial power distribution board and industrial power distribution board having the diverging connector kit, filed Dec. 3, 2008 and issued Mar. 24, 2011, discloses a branch connector kit for industrial distribution board and an industrial distribution board including the same are provided to connect a main bus bar to a branch bus bar by using the connector of clip type. A clip connector is formed into an electrical conductor. One among main bus bars for an electrical connection is inserted between the club connectors. A branch bus bar is connected to the clip connector and the circuit breaker for the branch wiring to electrically connect the clip connectors with a circuit breaker for a branch wiring. An insulating case electrically insulates the clip connector and the branch bus bar from the outside. A pair of contact pressure springs supplies an elastic force to the clip connector in order to maintain a contact pressure about the main bus bar. A connecting device connects the clip connector and the branch busbar.

Korean Patent No. 100540202 for Module assembly typed low-voltage distributing board, filed Jun. 22, 2005 and issued Jan. 10, 2006, discloses a switchgear for receiving power supplied by a power company and distributing power to each load of a customer. More particularly, the present invention relates to one or more cabinets and a main breaker and a power distribution unit installed inside the cabinet. A busbar connector for electrically connecting the circuit breaker, a busbar connector for electrically and mechanically connecting a plurality of orthogonal busbars, and a branch busbar installed in the horizontal or vertical direction in an orthogonal direction to electrically and mechanically distribute the circuit breaker. The present invention relates to a modular low-voltage switchgear that can be assembled quickly and easily without being cut, bent and holed by being configured to include a detachable adapter to be connected. In order to achieve the above object of the present invention, the module-assembled low-voltage switchgear according to the present invention, the first and second cabinets to form an inner space of a predetermined size and are installed in close contact with each other; (a) a first main busbar device connecting the input end of the main breaker installed in the first cabinet and the output side of the transformer; and (b) a plurality of branch booths installed horizontally inside the output end of the main breaker and the second cabinet. A busbar system including a second main busbar device for electrically connecting the bar, and (c) a branch busbar device including a plurality of detachable adapters which are orthogonal to the branch busbars and electrically and mechanically connected to each other; And a plurality of distribution breakers electrically and mechanically connected to the removable adapter.

International Patent Publication No. WO2009048427 for Bus-bar arrangement for electric distribution by inventor Lim, filed Aug. 21, 2008 and published Apr. 16, 2009, discloses the present invention provides a bus-bar assembly for 3-phase electricity distribution. In one embodiment, a neutral phase bus-bar is additionally provided for both 1-phase and 3-phases electricity distribution. Each bus-bar is integrally formed with contact fingers such that when the bus-bars are assembled in a substantially parallel and spaced apart manner on a base plate, the contact fingers are interspersed, ordered in a cyclic manner for 3-phase electric circuit. The contact fingers are dimensioned to fit and engage with inlet points of circuit breakers CB for electricity distribution. Hollow bushings or hollow bosses with stepped shoulders, in addition to washers, are used to electrically insulate each bus-bar from the base plate. The bus-bar assembly of the present invention was found to withstand severe short-circuit tests.

### SUMMARY OF THE INVENTION

The present invention relates to modular connection systems for breakers within an input/output (I/O) module, and more specifically to modular busbar connection systems providing for multiple interchangeable attachment points for attaching power supplying elements to a charger.

It is an object of this invention to reduce spatial inefficiency and improve reconfigurability for I/O modules for charging systems, especially for connecting to microgrids and distributed energy resources.

In one embodiment, the present invention is directed to a modular input/output module for a charging system comprising a plurality of primary busbars attached to a plurality of contactors at first ends of the plurality of primary busbars, wherein the plurality of primary busbars are configured to interlock with a plurality of secondary busbars at second ends of the plurality of primary busbars, wherein interlock points between the plurality of primary busbars and the plurality of secondary busbars are encased by at least one connector block, and wherein a section of the at least one connector block surrounding the interlock points is lined with at least one conductive material.

In another embodiment, the present invention is directed to a modular input/output module for a charging system comprising a plurality of primary busbars attached to a plurality of contactors at first ends of the plurality of primary busbars, wherein the plurality of primary busbars are configured to interlock with a plurality of secondary busbars at second ends of the plurality of primary busbars, and wherein interlock points between the plurality of primary busbars and the plurality of secondary busbars are encased by a single connector block.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a top orthogonal view of a bus-bar connection system according to one embodiment of the present invention.

FIG. 2 illustrates a side orthogonal view of a bus-bar connection system according to one embodiment of the present invention.

FIG. 3 illustrates a perspective view of a bus-bar connection system according to one embodiment of the present invention.

FIG. 4 illustrates a perspective view of a bus-bar connection system with bus-bars extending forward, right, and left according to one embodiment of the present invention.

FIG. 5 illustrates a perspective view of a bus-bar connection system with bus-bars extending entirely to the right according to one embodiment of the present invention.

FIG. 6 illustrates a perspective view of a bus-bar connection system with bus-bars extending entirely to the left according to one embodiment of the present invention.

### DETAILED DESCRIPTION

The present invention is generally directed to modular connection systems for breakers within an input/output (I/O) module, and more specifically to modular busbar connection systems providing for multiple interchangeable attachment points for attaching power supplying elements to a charger.

In one embodiment, the present invention is directed to a modular input/output module for a charging system comprising a plurality of primary busbars attached to a plurality of contactors at first ends of the plurality of primary busbars, wherein the plurality of primary busbars are configured to interlock with a plurality of secondary busbars at second ends of the plurality of primary busbars, wherein interlock points between the plurality of primary busbars and the plurality of secondary busbars are encased by at least one connector block, and wherein a section of the at least one connector block surrounding the interlock points is lined with at least one conductive material.

In another embodiment, the present invention is directed to a modular input/output module for a charging system comprising a plurality of primary busbars attached to a plurality of contactors at first ends of the plurality of primary busbars, wherein the plurality of primary busbars are configured to interlock with a plurality of secondary busbars at second ends of the plurality of primary busbars, and wherein interlock points between the plurality of primary busbars and the plurality of secondary busbars are encased by a single connector block.

Chargers, including electrical vehicle charging systems, are traditionally only connected to a single source at a time and usually charged directly from the grid. Therefore, chargers typically only have needed, and thus only provided, a single point of entry for power into the charging system. However, paradigms are shifting regarding how consumers draw power, as distributed energy resources (e.g., generators, solar panels, microgrid connections, etc.) become more important for providing power and islanding modes for home grids gain importance, it is no longer a safe assumption that chargers can deal with only being connected to a single energy source for the duration of their operations.

Take, for instance, the possibility of an energy consumer losing power to the grid. If an EV charging system relies on grid power in order to charge, that energy consumer is possibly left both without any power (and potentially heat and running water) and also without any practical means to travel to relative safety. Even if the consumer has on-site solar panels and/or a generator, if there is no way to easily reconfigure the charging station to attach to these resources, they don't help for the purposes of providing charge for transportation. In another instance, an individual wants to switch entirely from grid power to using power from their own neighborhood or household microgrid for sustainability or energy independence. In this situation, with prior art systems, either a new charging system needs to be purchased, a cumbersome installation of the charger needs to be performed, or spatially inefficient and potentially dangerous rewiring needs to be performed, none of which are ideal.

In today's energy economy, the issue of safe, quick, and efficient energy reconnection to chargers is not limited to needing to change energy supply to the charger. Bidirectional charging paradigms have increased in popularity, as electric vehicles have begun to be viewed not only as power consuming devices, but also as distributed power supply sources during times of need. Limited time charging of, for example, a home generator or home battery system therefore provides another good reason to have quick reconfigurability. For example, during a power outage, if a consumer is unable to practically leave with an electric vehicle anyways (i.e., they are snowed in) and have already exceeded the charge capacitor of a home generator or home battery system, being able to reconfigure the charger to supply power from the electric vehicle to the generator or battery (rather than being connected to the grid) is important for supplying much needed periods of warmth within the home.

Even if the power connection between the grid and the charging station is easily removable in a prior art system, there are additional challenges to reconnecting the charging station to different energy resources. One of those challenges is the direction from which the energy comes in from the new energy resource. For example, if a charging station has an existing connection to the grid at its left side, this connection is likely what was originally intended when installing the charging system and therefore the connection path is likely to be simple. However, if a battery system that needs to be connected to the charging station is on the right side of the charging station, then the path for connecting the battery system to the charging station is likely not as simple. This path is even potentially prohibitive for connecting to the battery system if the charging station is placed such that other connections cannot practically reach the left side. However, even if the left side is accessible, the connection to power sources on the right will likely require cables to be bent in order to reach. Bending of cables, especially for high power cables used in high energy charging situations, greatly reduces spatial efficiency, as the minimum bend radius of such cables tends to be large in order to prevent damage to the cable or issues with power transmission. This bend radius is often between about 6 and about 12 times the diameter of the cable.

In some situations, it is beneficial not to have to switch power sources connected to the input-output (I/O) module, but to have multiple sources connected at once and dynamically change which are used using control systems. This is often beneficial, as power source connections to the charging station are sometimes not beneficial to change repeatedly, as repeatedly unfastened and refastening the bolted connections between the cables and the breakers is often not good for the long-term health of the interconnect, as this sometimes causes a weakening of the connection point and therefore causes challenges with transmission that demand replacement.

The use of multiple, simultaneously connected energy resources does not, however, resolve the issue of configuring the entry leads into the charging apparatus. In fact, the improvements introduce new possible complications. For example, if the charging station is attached to a battery, a solar panel, and the grid, with one device entering the left side, one entering the top, and one entering the right side, this configuration is likely accommodated when the charging station is installed, but that doesn't mean these the relative positions of each power source will be consistent over time. For example, remodeling frequently requires a device such as a generator or solar panel to be shifted and this shift will sometimes move the device such that it is no longer convenient to attach it to the same side of the charging station. To account for this, it is beneficial to be able to alter how many connections are able to enter each side of the charging station. (e.g., to shift from allowing one in the right to allowing two in the right, even if this requires one fewer to enter the left). The inability to easily reorganize the connections is an issue because while initial orientation of the panel is often suitable for the connection at the time the breaker panel is installed, as the system scales, practical limitations often require the connected devices to be reorganized, potentially in a way that makes the original orientation of the breaker panel inefficient. While this doesn't necessarily make reorganization impossible, it does make the process more difficult and potential solutions typically unwieldy and spatially inefficient. For example, reorganization sometimes requires a cable connection to need to bend once or multiple times to reach the connected device, requiring additional space to account for the bend. These sorts of reorganizations often also lead to messy organization where it is sometimes difficult to untangle cords to determine where each connection goes, making subsequent changes even more difficult. Therefore, what is needed is a system that allows connection points to be dynamically changed to account for potential new configurations of connected cables.

Referring now to the drawings in general, the illustrations are for the purpose of describing one or more preferred embodiments of the invention and are not intended to limit the invention thereto.

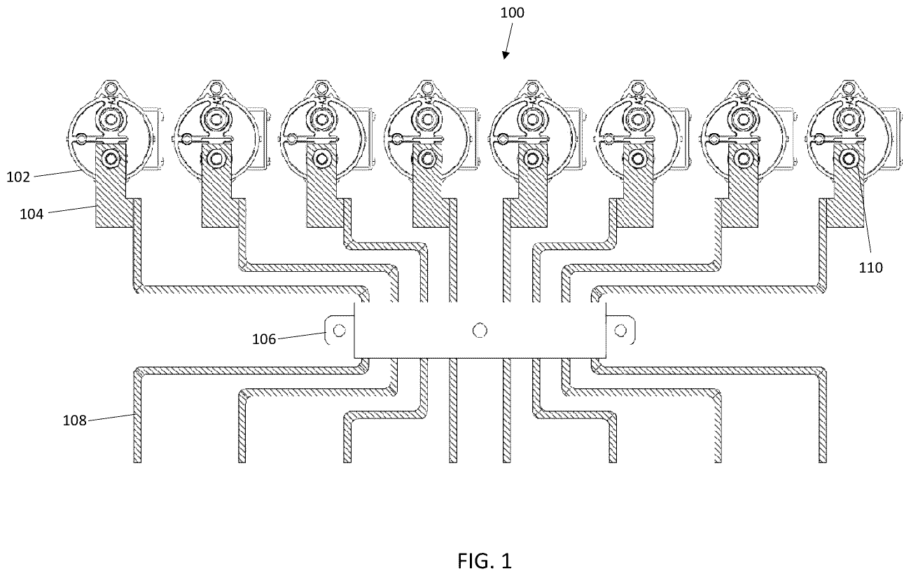

FIG. 1 illustrates a top orthogonal view of a bus-bar connection system according to one embodiment of the present invention. The circuit breaker bus-bar connection system 100 includes plurality of contactors 102 attached to primary busbars 104 extending outwardly from the plurality of contactors 102. In one embodiment, each of the plurality of contactors 102 is attached to a single busbar 104, as shown in FIG. 1. In one embodiment, the plurality of contactors 102 are attached to the primary busbars 104 via one or more bolts 110, screws, nails, and/or other attachment devices. One of ordinary skill in the art will understand that the means by which the plurality of contactors are attached to the busbars are not intended to be limiting according to the present invention, and the components are able to be welded as well. The busbars are preferably formed from one or more electrically conductive materials, such as metallic materials including copper, brass, and/or aluminum, but one of ordinary skill in the art will understand that the present invention is compatible with busbars formed from a variety of conductive materials.

The primary busbars 104 extend to a busbar connection module 106. Thus, a first end of the primary busbars 104 are connected to the plurality of contactors 102 and a second end of the primary busbars 104 are encapsulated by the busbar connection module 106. FIG. 1 shows eight breakers included in the system, but one of ordinary skill in the art will understand that the system is compatible with any numbers of breakers and is not limited to eight, nor does it require at least eight. Furthermore, FIG. 1 shows the breakers as being symmetrical, with the primary busbars 104 being bent towards the busbar connection module 106 in the center. However, the present invention is not limited to the embodiment shown in FIG. 1, and is able, for example, to have the busbar connection module 106 offset to the left of the breakers, such that the primary busbars 104 on the left side are straight and primary busbars 104 to the right are all bent in the same direction.

A plurality of secondary busbars 108 extends from a side of the busbar connection module 106 opposite the side where the primary busbars 104 enter. In one embodiment, cables are able to be connected to the ends of the secondary busbars 108 opposite the end encapsulated by the busbar connection module 106. Thus, a first end of the secondary busbars 108 is encapsulated by the busbar connection module 106 and a second end of the secondary busbars 108 is a terminal configured for cable connection. However, one of ordinary skill in the art will understand that cables are not limited to being attached to the ends of the secondary busbars 108, as most, if not all, of the secondary busbars 108 are conductive and therefore able to be attached to cables. In one embodiment, each of the primary busbars 104 and each of the secondary busbars 108 are formed from approximately the same material or formed from materials having approximately the same conductivities.

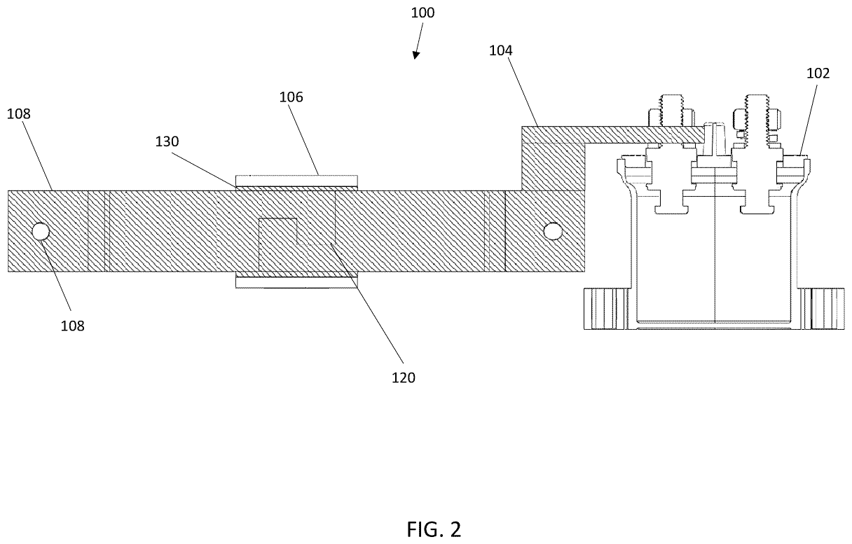

FIG. 2 illustrates a side orthogonal view of a bus-bar connection system according to one embodiment of the present invention. FIG. 2 shows one embodiment of an interlocking mechanism 120 between the primary busbars 104 and the secondary busbars 108 of the system. As shown in the embodiment in FIG. 2, in one embodiment, the interlocking mechanism 120 includes a first prong extending from the primary busbar 104 and a second prong extending from the secondary busbar 108. The first prong extends from the primary busbar 104 toward the secondary busbar 108 and the second prong extends from the secondary busbar 108 toward the primary busbar 104, such that the first prong and the second prong are substantially coplanar but oriented at different heights (e.g., the first prong extends from a bottom of the primary busbar 104 and the second prong extends from a top of the secondary busbar 108). A first subprong extends from the end of the first prong and a second subprong extends from the end of the second prong, such that the first subprong and the second subprong extend in opposite directions toward each other. The combinations of the prong and subprong attached to each busbar therefore forms a sort of “hook” mechanism configured to interlock with a corresponding hook mechanism on the opposite busbar. While this hook system does not necessarily keep the two busbars together alone, when surrounded by the busbar connection module 106, the system is held intact and in place. However, the present invention is also compatible with alternative interlocking mechanisms as well, as is understood by one of ordinary skill in the art. Preferably, the primary busbar 104 and the secondary busbar 108 are not connected by a bolt, screw, nail, weld, or any other firm attachment mechanism that would otherwise make the busbars more difficult to separate. The combination of the interlock mechanism 120 and the busbar connection module 106 therefore contributes to the modularity of the device and ease of disconnecting and reconnecting busbars.

In one embodiment, the second end of the primary busbar 104 and the first end of the secondary busbar 108 are encapsulated by the busbar connection module 106 in at least one passage within the busbar connection module 106 sized and configured such that the at least one passage has approximately the same height as the interlocked combination 120 of the primary and secondary busbars, such that the interlocked combination 120 is ensured to be held in place. In one embodiment, the at least one passage is lined with at least one conductive material 130 (e.g., copper, brass, aluminum, etc.) such that the contact interface between the inner walls of the at least one passage and the interlocked combination 120 of busbars is a connection of conductive material. In one embodiment, the at least one conductive material liner 130 of the at least one passage is the same material or has approximately the same conductivity as the material of one or more of the encapsulated busbars. The conductive material liner 130 is useful, as it helps to ensure consistent electrical connection between the primary busbars 104 and the secondary busbars 108, even where the primary busbars 104 and the secondary busbars 108 are slightly misaligned, as the liner 130 forms an additional conductive path.

Importantly, the busbar connection module 106 is able to act as a sort of vacuum breaker for all of the busbars simultaneously. For example, the busbar connection module 106 is able to be unscrewed, causing the connection between all of the primary busbars 104 and all of the secondary busbars 108 to fall out of contact, and therefore cut power to the module, improving the safety of repair and maintenance of the charging station. In a preferred embodiment, removing the busbar connection module 106 does not immediately disconnect all the busbars, but allows individual busbar connections to be disconnected. In one embodiment, individual busbar connections are able to be electronically disconnected by transmitting a signal to the magnetic contactors 102.

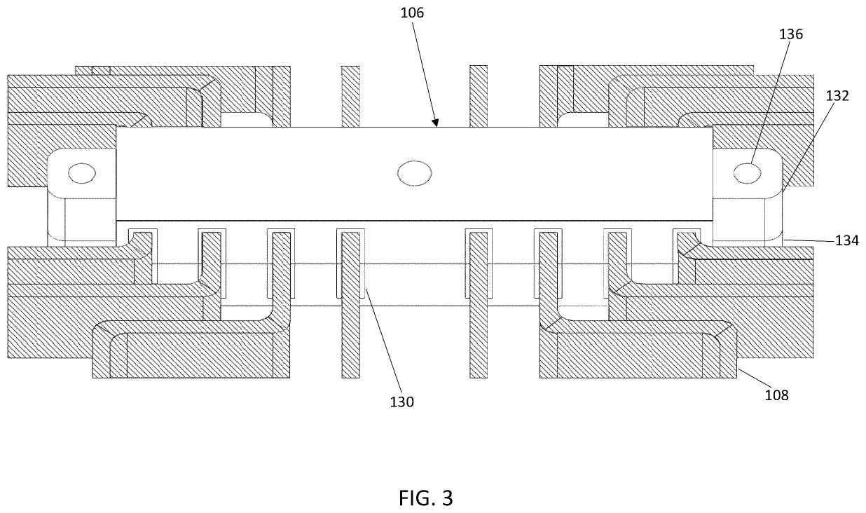

FIG. 3 illustrates a perspective view of a bus-bar connection system according to one embodiment of the present invention. The busbar connection module 106 includes a top subcomponent 132 and a bottom subcomponent 134. In one embodiment, the top subcomponent 132 and the bottom subcomponent 134 each include at least one attachment bore 136, configured to receive at least one bolt, at least one screw, and/or at least one nail for joining together and attaching the top subcomponent 132 and the bottom subcomponent 134. However, one of ordinary skill in the art will understand that the top subcomponent 132 and the bottom subcomponent 134 are able to be joined together via any method known in the art, including welding, adhesive, and/or any other means. In one embodiment, the top subcomponent includes a plurality of indentations having approximately the same width as the interlocked combination of a primary busbar and a secondary busbar. The bottom subcomponent includes a plurality of corresponding indentations having approximately the same width as the plurality of indentations of the top subcomponent. The plurality of indentations of the top subcomponent 132 and the bottom subcomponent 134 are configured such that, when the top subcomponent 132 and the bottom subcomponent 134 are joined together, the indentations of each subcomponent are aligned and form at least one passage through thickness of the busbar connection module 106 that is operable to receive an interlocked combination of primary and secondary busbars. In one embodiment, the width of the at least one passage is slightly larger than the interlocked combination of the busbars, in order to more easily accommodate the busbars.

As shown in FIG. 3, in one embodiment, the conductive lining 130 lines the top, bottom, and interior side walls of the at least one passage. In another embodiment, the conductive lining 130 lines only the top, only the bottom, only the interior side walls, and/or combination thereof of the at least one passage.

In one embodiment, the busbars are approximately 6 mm by approximately 25 mm. In one embodiment, the busbars are separated by approximately 10 mm. However, one of ordinary skill in the art will understand that the dimensions of the busbars and the separation between the busbars are able to depend on the current carrying capacities of the system and the individual busbars.

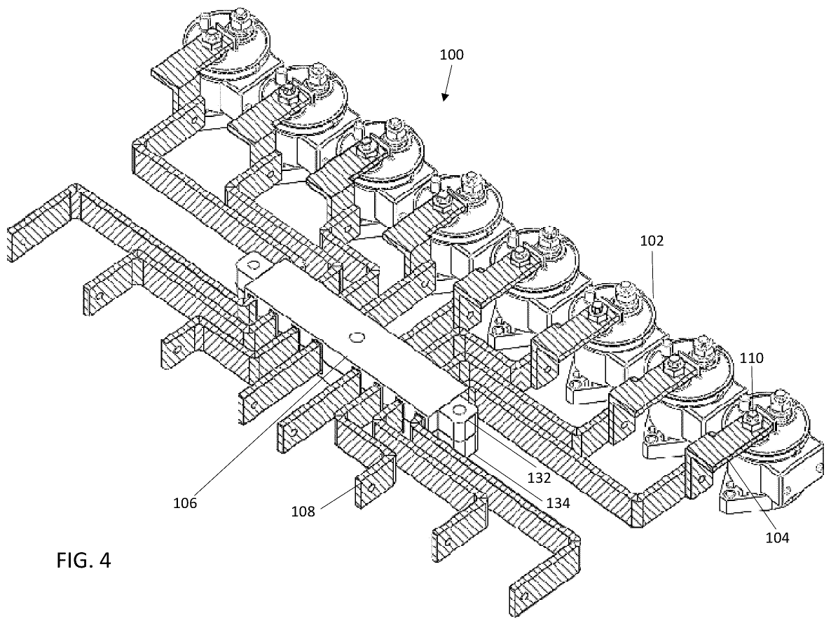

FIG. 4 illustrates a perspective view of a bus-bar connection system with bus-bars extending forward, right, and left according to one embodiment of the present invention. In one embodiment, the circuit breaker bus-bar connection system includes at least one substantial straight secondary busbar, at least one secondary busbar extending to the right, and at least one secondary busbar extending to the left. As shown in FIG. 4, in order to accommodate multiple secondary busbars extending to the left, the busbars must be bent and extend for different distances to the left or the right to avoid adjacent busbars. In one example, busbars further to the right, for example, extend further to the right to avoid adjacent busbars. Advantageously relative to using direct cable connections to the plurality of contactors 102, the primary and secondary busbars are able to extend at approximately 90° angles, rather than requiring a minimum bend radius like cables, providing improved spatial efficiency. However, one of ordinary skill in the art will understand that the busbars are able to extend at a range of angles including, but not limited to 30°, 45°, 60°, and/or any other angle. This balanced approach is useful if devices need to be connected around the breaker panel in different directions, in order to minimize the amount of bending of cables connected to the busbars. While FIG. 4 shows straight busbars extending from the center of the busbar connection module 106, other embodiments are also contemplated herein. By way of example and not limitation, in one embodiment, three leftmost busbars extend to the left, the next three busbars extend to the right, and the two rightmost busbars extend straight, as needed. Because the interlock system works at a busbar-by-busbar level, each secondary busbar 108 is easily able to be repositioned within the busbar connection module 106. As shown in FIG. 4, in one embodiment, each secondary busbar extends approximately the same length from the busbar connection module 106 along an axis approximately orthogonal to a central axis of the busbar connection module 106. However, one of ordinary skill in the art will understand that busbars of different lengths are able to be used as the situation demands.

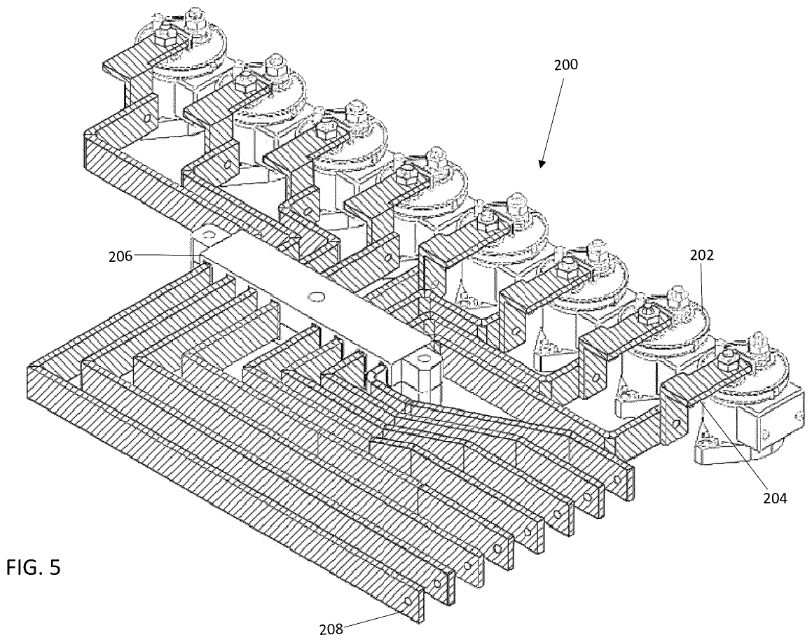

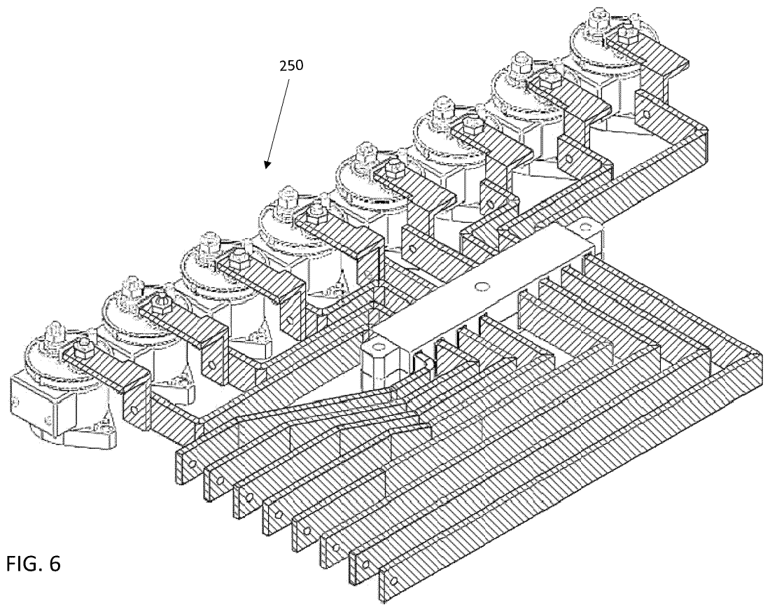

FIG. 5 illustrates a perspective view of a bus-bar connection system with bus-bars extending entirely to the right according to one embodiment of the present invention. In another embodiment, all of the terminals are able to extend in a single direction. In one embodiment, a bus-bar connection system 200 includes a plurality of contactors 202 attached to a plurality of primary busbars 204 (e.g., via a plurality of attachment mechanisms 210, such as bolts, screws, and/or other attachment mechanisms). The plurality of primary busbars 204 interlock with a plurality of secondary busbars 208 within a busbar connection module 206. In one embodiment, as shown in FIGS. 5 and 6, unlike the system illustrated in FIG. 4, the end of one or more of the secondary busbars 208 is substantially parallel to a central axis of the busbar connection module 206. This allows for easier connection for systems where all attached devices are on one side of the connection module. In another embodiment, a bus-bar connection system 250 is a mirror image of the system with all busbars extending to the left is also possible, as shown in FIG. 6.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A modular input/output module for a charging system, comprising:
a plurality of primary busbars, wherein proximal ends of the plurality of primary busbars are attached to a plurality of contactors;
a plurality of secondary busbars; and
at least one connector block;
wherein distal ends of the plurality of primary busbars interlock with proximal ends of the plurality of secondary busbars;
wherein the at least one connector block encases the interlocked sections of the plurality of primary busbars and the plurality of secondary busbars, thereby maintaining connection between the plurality of primary busbars and the plurality of secondary busbars; and
wherein an inner surface of the at least one connector block in contact with the plurality of primary busbars and the plurality of secondary busbars is lined with at least one electrically conductive material.

2. The module of claim 1, wherein the at least one connector block includes a top component and a bottom component, and wherein top component and the bottom component are connected by at least one connection means.

3. The module of claim 1, wherein distal ends of each of the plurality of secondary busbars are substantially parallel to each other and substantially orthogonal to the proximal ends of the plurality of secondary busbars.

4. The module of claim 1, wherein the plurality of primary busbars and/or the plurality of secondary busbars are connected to a plurality of power sources operable to supply power through the modular input/output module.

5. The module of claim 1, wherein the modular input/output module is connected to and providing power to at least one electric vehicle.

6. The module of claim 1, wherein the at least one electrically conductive material includes copper, aluminum, and/or brass.

7. The module of claim 1, wherein the distal ends of the plurality of primary busbars include one or more prongs configured to interlock with one or more prongs on the proximal ends of the plurality of secondary busbars via a hook mechanism.

8. The module of claim 1, wherein the interlocked distal ends of the plurality of primary busbars and the proximal ends of the plurality of secondary busbars are all substantially parallel.

9. A modular input/output module for a charging system, comprising:
at least one primary busbar, wherein a proximal end of the at least one primary busbar is attached to a plurality of contactors;
at least one secondary busbar; and
at least one connector block, including a top component and a bottom component;
wherein a distal end of the at least one primary busbar interlocks with a proximal end of the at least one secondary busbar;
wherein the top component and the bottom component of the at least one connector block are secured via welding, adhesive at least one screw, at least one nail, at least one latch, and/or at least bolt around the interlocked section of the at least one primary busbar and the at least one secondary busbar;
wherein the at least one connector block encases the interlocked section of the at least one primary busbar and the at least one secondary busbar, thereby maintaining connection between the at least one primary busbar and the at least one secondary busbar;
wherein an inner surface of the at least one connector block in contact with the at least one primary busbar and the at least one secondary busbar is lined with at least one electrically conductive material.

10. The module of claim 9, wherein the at least one primary busbar and/or the at least one secondary busbar are connected to a plurality of power sources operable to supply power through the modular input/output module.

11. The module of claim 9, wherein the modular input/output module is connected to and providing power to at least one electric vehicle.

12. The module of claim 9, wherein the at least one electrically conductive material includes copper, aluminum, and/or brass.

13. The module of claim 9, wherein the distal end of the at least one primary busbar includes one or more prongs configured to interlock with one or more prongs on the proximal end of the at least one secondary busbar via a hook mechanism.

14. The module of claim 9, wherein the interlocked distal end of the at least one primary busbar and the proximal end of the at least one secondary busbar are substantially parallel.

15. The module of claim 9, wherein a distal end of one or more of the at least one secondary busbar is substantially orthogonal to a proximal end of one or more of the at least one secondary busbar.

16. A modular input/output module for a charging system, comprising:
a plurality of primary busbars, wherein proximal ends of the plurality of primary busbars are attached to a plurality of contactors;
a plurality of secondary busbars; and
at least one connector block;
wherein distal ends of the plurality of primary busbars interlock with proximal ends of the plurality of secondary busbars;
wherein the at least one connector block encases the interlocked sections of the plurality of primary busbars and the plurality of secondary busbars, thereby maintaining connection between the plurality of primary busbars and the plurality of secondary busbars; and
wherein the plurality of primary busbars and/or the plurality of secondary busbars are connected to a plurality of power sources operable to supply power through the modular input/output module.

17. The module of claim 16, wherein the at least one connector block includes a top component and a bottom component, and wherein top component and the bottom component are connected by at least one connection means.

18. The module of claim 16, wherein the modular input/output module is connected to and providing power to at least one electric vehicle.

19. The module of claim 16, wherein the distal ends of the plurality of primary busbars include one or more prongs configured to interlock with one or more prongs on the proximal ends of the plurality of secondary busbars via a hook mechanism.

20. The module of claim 16, wherein the interlocked distal ends of the plurality of primary busbars and the proximal ends of the plurality of secondary busbars are all substantially parallel.
